(19) United States
(12) Patent Application Publication
(10) Pub. No.: US 2024/0143906 A1
(43) Pub. Date: May 2, 2024

(54) CHARACTER LEVEL EMBEDDINGS FOR SPREADSHEET DATA EXTRACTION USING MACHINE LEARNING

(71) Applicant: INTUIT INC., Mountain View, CA (US)

(72) Inventors: Mithun GHOSH, Bangalore (IN); Vignesh Thirukazhukundram SUBRAHMANIAM, Bangalore (IN)

(21) Appl. No.: 18/050,087

(22) Filed: Oct. 27, 2022

(51) Int. Cl. G06F 40/18

(52) U.S. Cl. CPC G06F 40/18

(57) ABSTRACT

Aspects of the present disclosure provide techniques for automated data classification through machine learning. Embodiments include determining, by a machine learning model, character-level embeddings of a plurality of characters from a text string. Embodiments include processing, by the machine learning model, the character-level embeddings through one or more bi-directional long short term memory (LSTM) layers. Embodiments include outputting, by the machine learning model based on the processing, a predicted label for the text string indicating a classification of the text string. Embodiments include performing, by a computing application, one or more actions based on the text string and the predicted label.

Aspects of the present disclosure relate to techniques for using machine learning to extract data from spreadsheets. In particular, techniques described herein involve learning character level embeddings of text within cells of spreadsheets for use in predicting classifications of the text via a machine learning model.

### BACKGROUND

Every year millions of people, businesses, and organizations around the world utilize software applications to assist with countless aspects of life. In some cases, users may be required to input substantial amounts of data into software applications, such as in connection with various processing tasks. While some applications allow data to be imported from existing documents, these techniques generally only work for documents that are structured in particular ways and/or have certain associated metadata. Thus, there are many cases in which users must manually enter data from documents into a software application without the ability to accurately import the data automatically from the document, such as for documents that are not structured in a particular manner that is required by a particular software application and/or that do not contain particular metadata.

As such, there is a need in the art for improved techniques of automatically extracting data from documents.

### BRIEF SUMMARY

Certain embodiments provide a method for automated data classification through machine learning. The method generally includes: determining, by a machine learning model, character-level embeddings of a plurality of characters from a text string, wherein: each respective character-level embedding of the character-level embeddings is a vector representation of a respective character of the plurality of characters; and the machine learning model was trained to determine the character-level embeddings based on training data comprising text strings associated with known labels indicating known classifications of the text strings; processing, by the machine learning model, the character-level embeddings through one or more bi-directional long short term memory (LSTM) layers; and outputting, by the machine learning model based on the processing, a predicted label for the text string indicating a classification of the text string; and performing, by a computing application, one or more actions based on the text string and the predicted label.

Other embodiments provide a method for training a machine learning model. The method generally includes: receiving, by a machine learning model, inputs comprising a plurality of characters from a text string, wherein the text string is associated with a known label indicating a classification of the text string; processing, by the machine learning model, the inputs through an embedding layer that determines character-level embeddings of the plurality of characters, wherein each respective character-level embedding of the character-level embeddings is a vector representation of a respective character of the plurality of characters; processing, by the machine learning model, the character-level embeddings through one or more bi-directional long short term memory (LSTM) layers; determining, by the machine learning model based on one or more outputs from the one or more bi-directional LSTM layers, a predicted label for the text string; and adjusting one or more parameters of the embedding layer based on a comparison of the predicted label with the known label.

Other embodiments provide a system comprising one or more processors and a non-transitory computer-readable medium comprising instructions that, when executed by the one or more processors, cause the system to perform a method. The method generally includes: determining, by a machine learning model, character-level embeddings of a plurality of characters from a text string, wherein: each respective character-level embedding of the character-level embeddings is a vector representation of a respective character of the plurality of characters; and the machine learning model was trained to determine the character-level embeddings based on training data comprising text strings associated with known labels indicating known classifications of the text strings; processing, by the machine learning model, the character-level embeddings through one or more bi-directional long short term memory (LSTM) layers; and outputting, by the machine learning model based on the processing, a predicted label for the text string indicating a classification of the text string; and performing, by a computing application, one or more actions based on the text string and the predicted label.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of utilizing a machine learning model to determine a classification of a text string from a document as described herein.

FIG. 2 depicts an example of a machine learning model that utilizes character-level embeddings for classifying text strings as described herein.

FIG. 3 depicts an example of training a machine learning model that utilizes character-level embeddings for classifying text strings as described herein.

FIG. 4 depicts example operations related to automated data classification through machine learning.

FIG. 5 depicts example operations related to training a machine learning model.

FIG. 6 depicts an example processing system for training and/or utilizing a machine learning model to determine a classification of a text string from a document as described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for training and utilizing a machine learning model to determine a classification of a text string from a document based on character-level embeddings.

According to certain embodiments, machine learning techniques are utilized in order to predict classifications of text strings in documents such as spreadsheets, such as to enable automated import of data from such documents without the need for the documents to correspond to any particular format. Spreadsheets generally contain granular strings of text within separate “cells” organized in rows and columns, and the text often includes numbers and symbols in addition to letters. Thus, existing machine learning techniques for classifying data from documents based on meanings of words (e.g., vector representations of words that represent the meanings of words in n-dimensional space) are generally ineffective for extracting data from spreadsheets and other similar documents. For example, the use of word-level embeddings is unlikely to produce meaningful results for the contents of a spreadsheet representing payroll data of a business, as such a document will not contain many words.

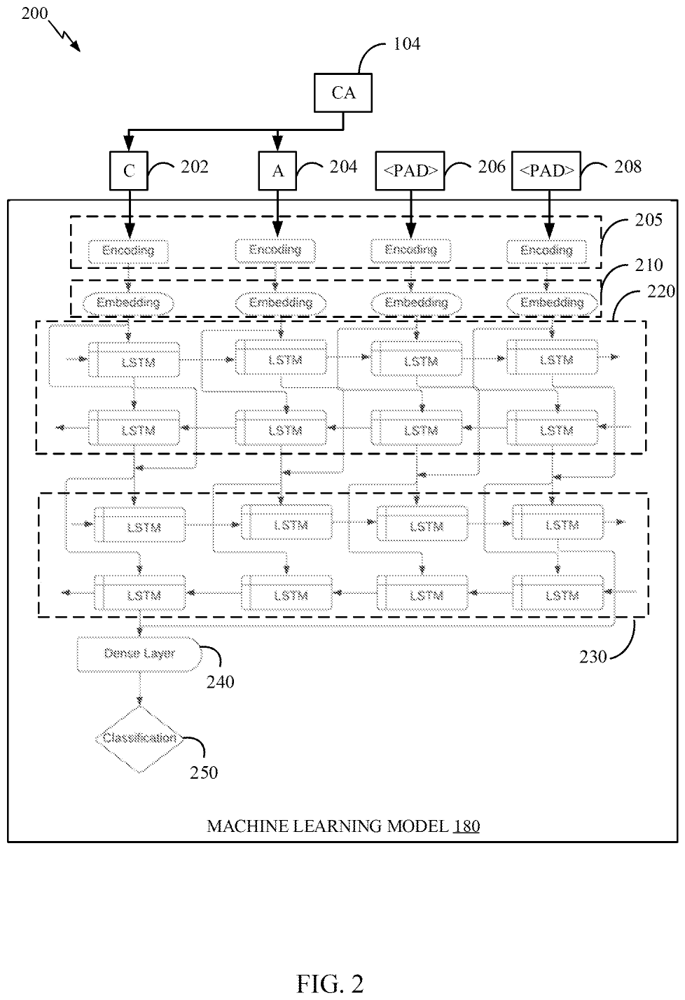

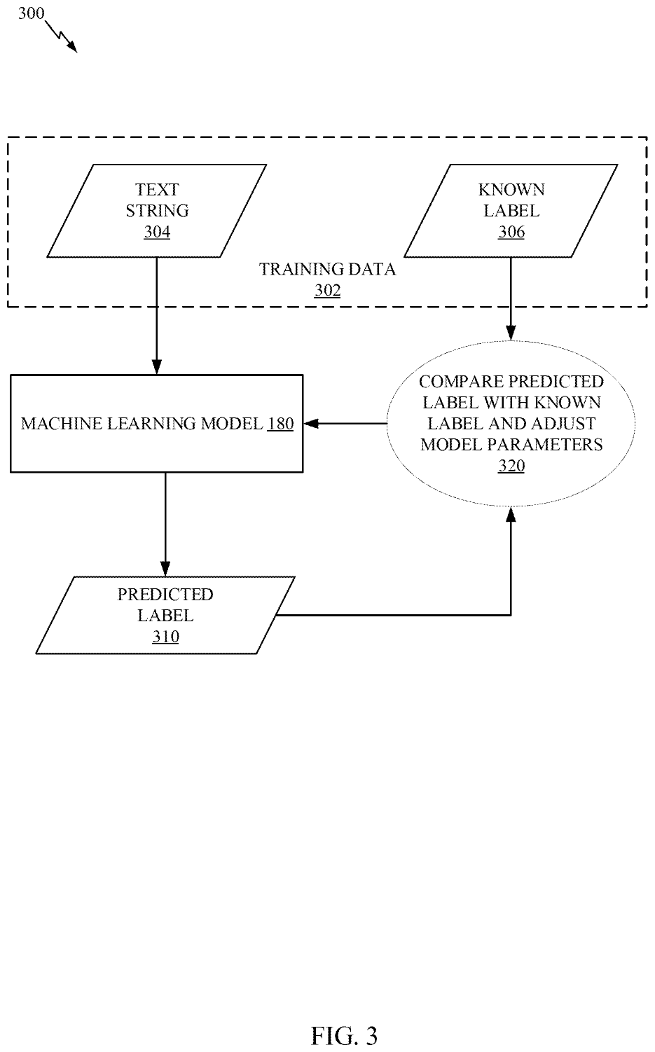

In contrast to existing techniques based on word-level embeddings, embodiments of the present disclosure use a machine learning model that generates character-level embeddings of text strings from a document in order to accurately classify the text strings. Character-level embeddings are n-dimensional vectors representing characters as vectors in n-dimensional space. In some embodiments, as described in more detail below with respect to FIGS. 2 and 3, an embedding layer (e.g., comprising one or more fully-connected layers) of the machine learning model is trained to generate character-level embeddings based on which character-level embeddings produce the most accurate ultimate classifications from the machine learning model, such as based on a training data set of text strings with known classifications (e.g., using backpropagation). Furthermore, as described below, one or more bi-directional long short term memory (LSTM) layers of the machine learning model may also be trained to further optimize character-level embeddings for classification accuracy. Thus, the character-level embeddings generated by the machine learning model are optimized for classification accuracy. Once trained, the machine learning model is used to determine a classification for a given text string from a document (e.g., a spreadsheet) using character-level embeddings of the characters in the given text string.

Embodiments of the present disclosure provide multiple improvements over conventional techniques for automatic classification of text from documents. For example, by utilizing machine learning techniques to analyze text strings from documents based on character-level embeddings of the text strings in view of historically-classified text strings, techniques described herein allow for text to be classified and extracted from a document even when the document is not in a particular format or does not contain any particular metadata. Furthermore, by learning character-level embeddings instead of word-level embeddings, embodiments of the present disclosure provide accurate automated classifications even of text that includes characters such as numbers and symbols rather than or in addition to words, unlike other existing machine learning techniques.

Additionally, by training the machine learning model (including the embedding layer) for classification accuracy, techniques described herein allow character-level embeddings to be learned in a manner that optimizes model accuracy and therefore results in better model performance. The use of embeddings further allows a machine learning model to be trained not only to identify particular text strings that have previously been determined to correspond to particular classifications, but also to identify latent similarities indicated by similarities between embeddings. Embodiments of the present disclosure provide improved machine learning techniques, and allow for improved automated extraction of data from documents, particularly from spreadsheets.

### Automated Extraction of Data from Spreadsheets

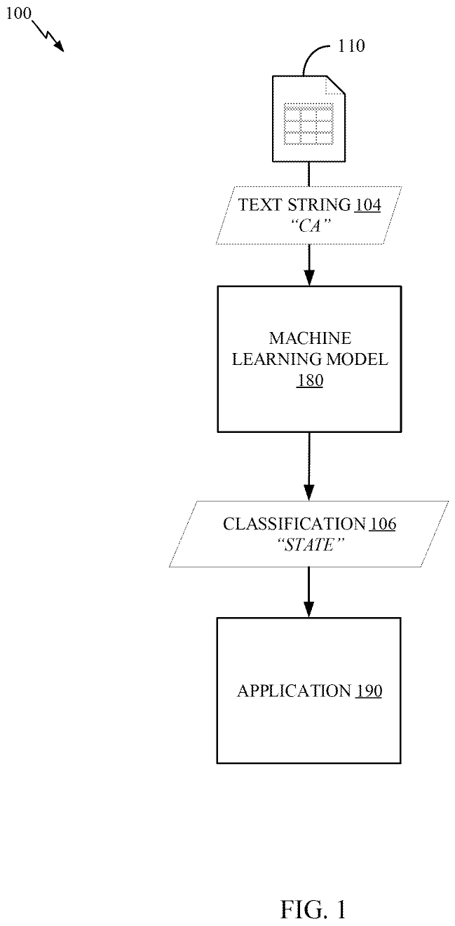

FIG. 1 is an illustration 100 of utilizing a machine learning model to determine a classification of a text string from a document such as a spreadsheet as described herein.

Document 110 represents a spreadsheet that includes a plurality of text strings contained within cells that are organized into columns and rows. A spreadsheet is included as an example, and techniques described herein may be used to classify text strings from other types of documents. In one example, document 110 is a spreadsheet containing payroll data related to a business. A user of application 190 may wish to import the contents of document 110 into application 190 without manually entering the data into application 190. For example, application 190 may be a software application that provides financial services such as accounting and/or tax preparation functionality.

A machine learning model 180 is used to automatically determine classifications of text strings in document 110. Machine learning model 180 may, for example, be a neural network. For example, a first text string 104 may correspond to a cell in document 110, and comprises the text “CA”. One or more inputs are provided to machine learning model 180 based on text string 104, and machine learning model 180 outputs a classification 106 in response to the one or more input. Classification 106 indicates that text string 104 is classified as a “STATE”. Operation and training of machine learning model 180 are described in more detail below with respect to FIGS. 2 and 3. For example, machine learning model 180 may generate character-level embeddings of text string 104 for use in determining classification 106.

Application 190 may use classification 106 to perform one or more operations, such as importing text from document 110. For example, application 190 may populate a variable corresponding to a state (e.g., a state in which an employee words or resides) with the text string 104 based on classification 106. Thus, the contents of document 110 may be automatically imported into application 190 despite document 110 not conforming to any particular format or containing any particular metadata, and despite containing few or no words. Furthermore, data automatically imported into application 190 using techniques described herein may be displayed via a user interface.

In some cases a user may provide feedback with respect to classification 106, such as based on reviewing results of an automated import via a user interface. For example, the user may provide input indicating whether classification 106 is correct and/or providing a corrected classification for text string 104. The user feedback may be used to generate updated training data for re-training machine learning model 180. For instance, a new training data instance comprising text string 104 and a label that is based on the user feedback may be generated and used in a model training process. The re-trained model may then be used to determine subsequent classifications of text strings with improved accuracy. Training of machine learning model 180 is described in more detail below with respect to FIG. 3.

### Example Machine Learning Model

FIG. 2 is an illustration 200 of an example machine learning model that utilizes character-level embeddings for classifying text strings as described herein. Illustration 200 comprises machine learning model 180 and text string 104 of FIG. 1.

Text string 104 comprises two characters 202 and 204 (e.g., “C” and “A”), which are used to provide inputs to machine learning model 180. Each of characters 202 and 204 is encoded at an encoding layer 205 (e.g., which may represent a layer of the model, such as an input layer of the model, or encoding may be performed prior to providing inputs to the model). Encoding generally comprises generating an encoded representation of a character based on a “dictionary” or “alphabet” that maps characters to numerical identifiers such as numbers. For example, a dictionary may include a set of possible characters associated with index values (e.g., successive integers). In one (non-limiting) example the dictionary maps the characters ‘ABCDEFGHIJKLMNOPQRSTUVWXYZabcdefghijklmnopqrstuvwxyz0123456789,;.!?:\′″∧|_@#$%\hat{ }&*˜′+−=< >( )[ ]{ } . . . ’ to index values 1−n, where n is the number of characters in the dictionary. In some cases, certain index values are used for characters that are not included in the dictionary. For example, the index value 0 may be used for any character that is not included in the dictionary. Other implementations are possible without departing from the scope of the present disclosure.

Using the example dictionary above, character 202 (C) may be mapped to the index value 3 and character 204 (A) may be mapped to the index value 1. In some embodiments, encoding involves generating a one-hot encoded vector that represents the index value of a given character. For example, a one-hot encoded vector may have a number of binary values that is equal to the number of possible index values (e.g., the vector beginning with a value corresponding to the index value 0), and the ith value of the vector may be set to one if the vector represents the character corresponding to index value i, while all other values will be set to 0. For example, if the 0^{th} value of a one-hot encoded vector is set to 1, then the one-hot encoded vector represents the index value of 0, which may indicate an unrecognized character.

In an example, the character C is represented by the one-hot encoded vector {0, 0, 0, 1, 0, . . . . } (e.g., representing an index value of 3) and the character A is represented by the one-hot encoded vector {0, 1, 0, . . . } (e.g., representing an index value of 1). Other implementations are possible.

Pad inputs 208 may be provided to other nodes of an input layer of machine learning model 180. For example, the input layer may have a size that is based on a maximum number of characters that is expected for a text string (e.g., 128 as a non-limiting example), and pad inputs (e.g., having a null or 0 value) may be added to the characters in a given text string in order to provide a number of inputs equal to the size of the input layer of the model.

The encoded character values are then provided to an embedding layer 210 of machine learning model 180 where they are transformed into character-level embeddings. Embedding layer 210 may comprise, for example, one or more fully-connected layers. In an example, each node of embedding layer 210 may receive an encoded character, which may be an x-dimensional one-hot encoded vector where x is equal to the total number of possible index values, and may generate an n-dimensional vector based on the encoded character. For example, each node of embedding layer 210 may apply a matrix transformation to the x-dimensional one-hot encoded vector in order to produce an n-dimensional vector (e.g., of floating point values). The matrix used by embedding layer 210 to transform encoded characters into n-dimensional vectors may be learned through a supervised training process as described in more detail below with respect to FIG. 3, such as to optimize classification accuracy of machine learning model 180.

Character-level embeddings determined by embedding layer 210 are then processed through two bi-directional LSTM layers 220 and 230. In a neural network, each node or neuron in an LSTM layer generally includes a cell, an input gate, an output gate and a forget gate. The cell generally stores or “remembers” values over certain time intervals in both a backward direction (e.g., data input to the node) and a forward direction (e.g., data output by the node), and the gates regulate the flow of data into and out of the cell. As such, an LSTM layer hones a representation (e.g., embedding) by modifying vectors based on remembered data, thereby providing a more contextualized representation of a text sequence. A bi-directional LSTM operates in both a forward and backward direction.

It is noted that while two bi-directional LSTM layers 220 and 230 are shown, alternative embodiments may involve more or fewer bi-directional LSTM layers and/or one or more standard LSTM layers.

After the character-level embeddings are honed through bi-directional LSTM layers 220 and 230, the honed character-level embeddings are processed through a dense layer 240. Dense layer 240 represents a fully-connected layer of machine learning model 180. Fully connected layers in a neural network are layers where all the inputs from one layer are connected to every activation unit of the next layer.

Outputs from dense layer 240 may undergo a dropout in some embodiments. The term “dropout” refers to dropping out certain nodes in a neural network, such as based on a “drop probability” value that indicates how many nodes to drop. In some cases, nodes to drop are identified through random selection. For instance, if dense layer 240 has 1000 neurons (nodes) and a dropout is applied with drop probability=0.5, then 500 neurons would be randomly dropped in every iteration.

Outputs from dense layer 240 (e.g., after a dropout in some embodiments) are used to determine a classification 250. For example, a softmax layer may apply a softmax activation function to one or more outputs from dense layer 240 in order to determine classification 250. A Softmax activation function converts numeric outputs of the last linear layer of a multi-class classification neural network into probabilities by taking the exponents of each output and then normalizing each number by the sum of those exponents such that the entire output vector (e.g., including all of the probabilities) adds up to one.

Classification 250 may be output by machine learning model 180, and generally represents a predicted classification of text string 104. For example, classification 250 may be output as classification 106 of FIG. 1, indicating that the text string “CA” is classified as a “STATE”.

### Training a Machine Learning Model that Utilizes Character-Level Embeddings for Classifying Text Strings

FIG. 3 is an illustration 300 of an example of training a machine learning model that utilizes character-level embeddings for classifying text strings as described herein. Illustration 300 includes machine learning model 180 of FIGS. 1 and 2. For example, training operations may be performed by a model training component.

Training data 302 may include a plurality of text strings (represented by example text string 304) associated with known labels (represented by example known label 306). For example, training data 302 may include a plurality of text strings that have previously been classified by a user or expert, and the labels may indicate these known classifications.

There are many different types of machine learning models that can be used in embodiments of the present disclosure. For example, machine learning model 180 may be a neural network. Machine learning model 180 may also be an ensemble of several different individual machine learning models. Such an ensemble may be homogenous (i.e., using multiple member models of the same type) or non-homogenous (i.e., using multiple member models of different types). Individual machine learning models within such an ensemble may all be trained using the same subset of training data or may be trained using overlapping or non-overlapping subsets randomly selected from the training data.

Neural networks generally include a collection of connected units or nodes called artificial neurons. The operation of neural networks can be modeled as an iterative process. Each node has a particular value associated with it. In each iteration, each node updates its value based upon the values of the other nodes, the update operation typically consisting of a matrix-vector multiplication. The update algorithm reflects the influences on each node of the other nodes in the network. As described in more detail above with respect to FIG. 2, machine learning model 180 may be a neural network that comprises an embedding layer, one or more bi-directional LSTM layers, one or more dense layers, and a softmax layer.

In some embodiments, training machine learning model 180 is a supervised learning process that involves providing training inputs representing text strings (e.g., characters of text string 304) as inputs to machine learning model 180. Machine learning model 180 processes the training inputs through its various layers and outputs predictions (e.g., predicted label 310) indicating predicted classifications with respect to the text strings represented by the inputs. Predictions may, in some embodiments, be in the form of probabilities with respect to each possible classification, such as indicating a likelihood that a text string corresponds to each of a set of possible classifications. The predictions (e.g., predicted label 310) are compared to the known labels associated with the training inputs (e.g., known label 306) to determine the accuracy of machine learning model 180, and machine learning model 180 is iteratively adjusted until one or more conditions are met. For instance, the one or more conditions may relate to an objective function (e.g., a cost function or loss function) for optimizing one or more variables (e.g., classification accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for machine learning model 180, such as based on validation data and test data, as is known in the art.

For example, at step 320, parameters of the various layers of machine learning model 180 are iteratively adjusted until predicted label 310 matches known label 306 or until some other condition is met, such as optimization of an objective function or the occurrence of a successive number of iterations with minimal or no improvement.

In some embodiments, back-propagation is used to train the model. Back-propagation generally refers to a process of calculating a gradient based on a loss function, comparing recreated input with the actual input. By propagating this gradient “back” through the layers of the model, the weights and/or other parameters can be modified to produce more accurate outputs on subsequent attempts to recreate the input.

A loss function is a type of objective function used to minimize “loss” (e.g., the value calculated by the loss function) during training iterations for a machine learning model. Components included in a loss function may relate to the determined accuracy of the machine learning model during a given training iteration with respect to one or more particular conditions.

Minimizing a loss function during model training generally involves searching for a candidate solution (e.g., a set of model parameters including weights and biases, and the like) that produces the lowest value as calculated by the custom loss function. According to certain embodiments of the present disclosure, an objective function such as a loss function is designed to minimize classification inaccuracy (e.g., prioritizing accuracy of predicted labels such as predicted label 310).

In certain embodiments, the layers of machine learning model 180, such as an embedding layer, one or more bi-directional LSTM layers, and a dense layer, may be trained based on classification accuracy. Thus, machine learning model 180 is trained to generate character-level embeddings that are best suited for accurately classifying text strings, such as text strings from spreadsheets that commonly contain text other than words.

Once trained, machine learning model 180 may be used as described herein to determine classifications of text strings based on character-level embeddings of the text strings, such as for automatically extracting text from spreadsheets.

### Example Operations for Automated Data Classification Through Machine Learning

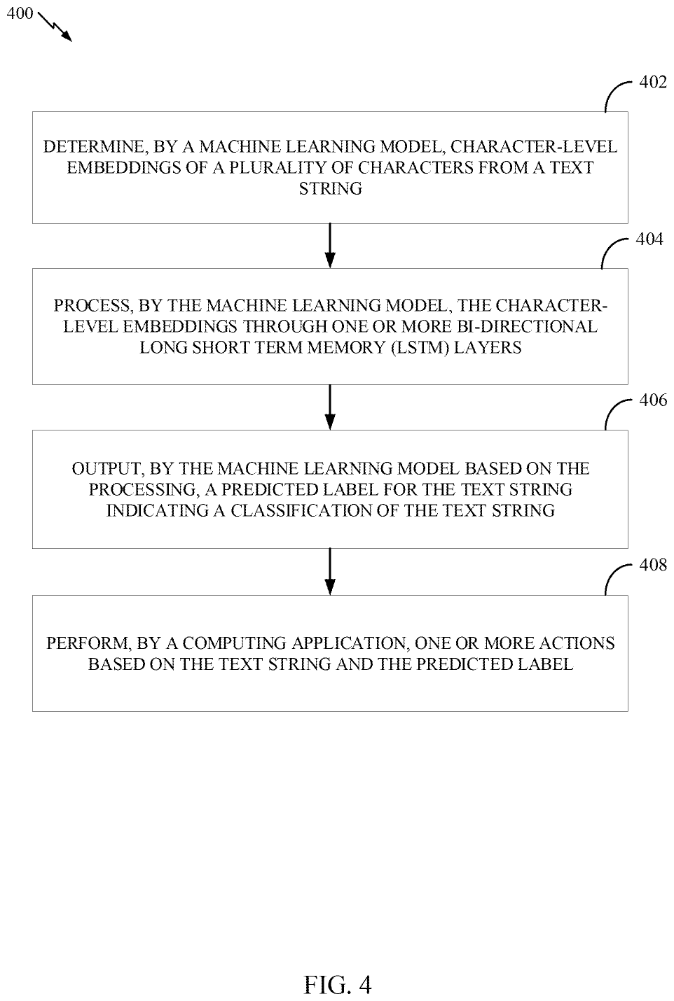

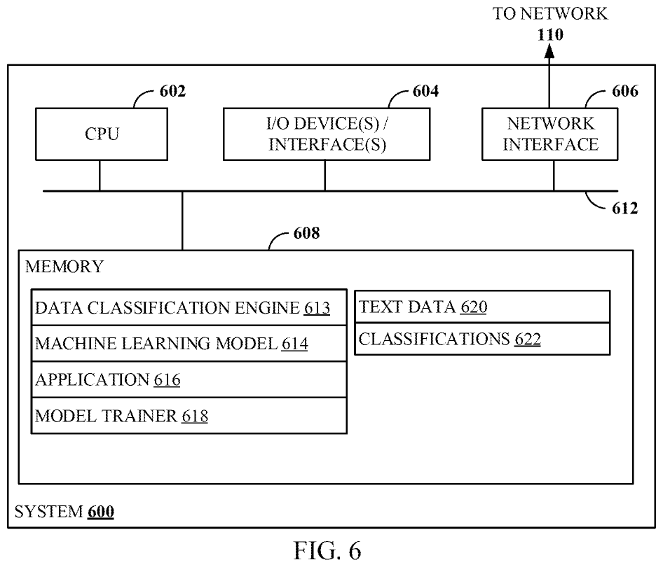

FIG. 4 depicts example operations 400 for automated data classification through machine learning. For example, operations 400 may be performed by data classification engine 613 of FIG. 6 and/or additional components depicted in FIGS. 1-3.

Operations 400 begin at step 402 with determining, by a machine learning model, character-level embeddings of a plurality of characters from a text string. In some embodiments each respective character-level embedding of the character-level embeddings is a vector representation of a respective character of the plurality of characters, and the machine learning model was trained to determine the character-level embeddings based on training data comprising text strings associated with known labels indicating known classifications of the text strings.

In some embodiments, determining, by the machine learning model, the character-level embeddings of the plurality of characters from the text string comprises generating one-hot encoded vectors of the plurality of characters using a character dictionary and generating the character-level embeddings based on multiplying the one-hot encoded vectors by a matrix. For example, the matrix may be learned based on the training data. The character dictionary may comprise mappings of characters to numerical identifiers.

Operations 400 continue at step 406, with processing, by the machine learning model, the character-level embeddings through one or more bi-directional long short term memory (LSTM) layers. Certain embodiments further comprise processing, by the machine learning model, one or more outputs from the one or more bi-directional LSTM layers through one or more fully-connected layers. Furthermore, some embodiments further comprise processing, by the machine learning model, one or more outputs from the one or more fully-connected layers, through a softmax layer to determine the predicted label.

Operations continue at step 408, with outputting, by the machine learning model based on the processing, a predicted label for the text string indicating a classification of the text string.

Operations 400 continue at step 410, with performing, by a computing application, one or more actions based on the text string and the predicted label. For example, performing, by the computing application, the one or more actions based on the text string and the predicted label may comprises one or more of automatically populating a particular variable with the text string based on the predicted label or providing output to a user via a user interface based on the text string and the predicted label.

Some embodiments further comprise receiving user input related to the predicted label and generating updated training data for re-training the machine learning model based on the user input and the text string.

Notably, operations 400 is just one example with a selection of example steps, but additional methods with more, fewer, and/or different steps are possible based on the disclosure herein.

### Example Operations for Training a Machine Learning Model

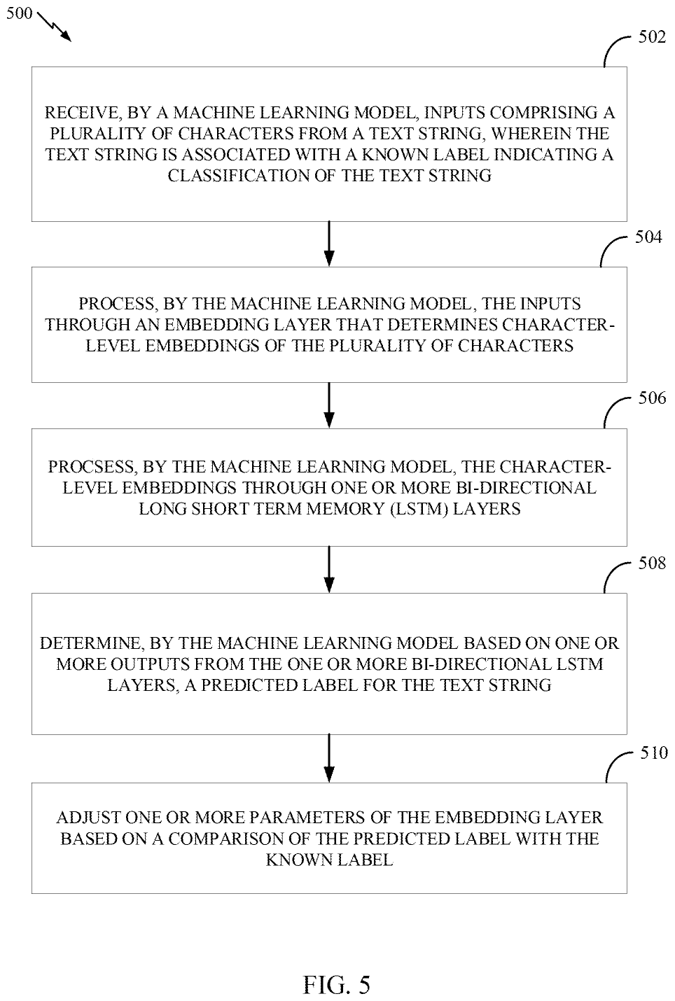

FIG. 5 depicts example operations 500 for training a machine learning model. For example, operations 500 may be performed by model trainer 618 of FIG. 6 and/or additional components depicted in FIGS. 1-3.

Operations 500 begin at step 502 with receiving, by a machine learning model, inputs comprising a plurality of characters from a text string, wherein the text string is associated with a known label indicating a classification of the text string.

Operations 500 continue at step 504, with processing, by the machine learning model, the inputs through an embedding layer that determines character-level embeddings of the plurality of characters, wherein each respective character-level embedding of the character-level embeddings is a vector representation of a respective character of the plurality of characters.

In some embodiments, processing, by the machine learning model, the inputs through the embedding layer comprises generating one-hot encoded vectors of the plurality of characters using a character dictionary and generating the character-level embeddings based on multiplying the one-hot encoded vectors by a matrix.

Operations 500 continue at step 506, with processing, by the machine learning model, the character-level embeddings through one or more bi-directional long short term memory (LSTM) layers.

Operations 500 continue at step 508, with determining, by the machine learning model based on one or more outputs from the one or more bi-directional LSTM layers, a predicted label for the text string.

Operations 500 continue at step 510, with adjusting one or more parameters of the embedding layer based on a comparison of the predicted label with the known label. Some embodiments further comprise adjusting one or more parameters of the one or more bi-directional LSTM layers based on the comparison of the predicted label with the known label. Certain embodiments further comprise processing, by the machine learning model, the one or more outputs from the one or more bi-directional LSTM layers through one or more fully-connected layers and adjusting one or more parameters of the one or more fully-connected layers based on a comparison of the predicted label with the known label.

In some embodiments, adjusting the one or more parameters of the embedding layer based on the comparison of the predicted label with the known label comprises adjusting one or more values of the matrix.

Notably, operations 500 is just one example with a selection of example steps, but additional methods with more, fewer, and/or different steps are possible based on the disclosure herein.

### Example Computing System

FIG. 6 illustrates an example system 600 with which embodiments of the present disclosure may be implemented. For example, system 600 may be configured to perform operations 500A of FIG. 5A and/or operations 500B of FIG. 5B.

System 600 includes a central processing unit (CPU) 602, one or more I/O device interfaces 604 that may allow for the connection of various I/O devices 614 (e.g., keyboards, displays, mouse devices, pen input, etc.) to the system 600, network interface 606, a memory 608, and an interconnect 612. It is contemplated that one or more components of system 600 may be located remotely and accessed via a network 110. It is further contemplated that one or more components of system 600 may comprise physical components or virtualized components.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory or the like. In some embodiments, memory 608 may comprise a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, memory 608 includes data classification engine 613, which may perform operations described herein related to automated data classification through machine learning, such as operations 400 of FIG. 4. For example, data classification engine 613 may use machine learning model 614 to automatically classify text extracted from documents as described herein. Alternatively, data classification engine 613 may be part of application 616.

Memory 608 includes machine learning model 614 and application 616, which may be representative of machine learning model 180 and application 190 of FIG. 1.

Memory 608 further comprises text data 620, which may include text string 104 of FIG. 1 and text string 304 of FIG. 3. Memory 608 further comprises classifications 622, which may include classification 106 of FIG. 1, classification 250 of FIG. 2, and known label 306 and predicted label 310 of FIG. 3.

### ADDITIONAL CONSIDERATIONS

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for automated data classification through machine learning, comprising:
determining, by a machine learning model, character-level embeddings of a plurality of characters in a text string from a cell of a spreadsheet, wherein:
the character level embeddings are determined by an embedding laver of the machine learning model comprising a plurality of nodes that apply matrix transformations to one-hot encoded vectors representing the plurality of characters in order to produce vectors of floating point values;
the matrix transformations involve a matrix learned through a supervised training process;
each respective character-level embedding of the character-level embeddings is a vector representation of a respective character of the plurality of characters; and
the machine learning model was trained to determine the character-level embeddings based on training data comprising text strings associated with known labels indicating known classifications of the text strings, wherein each of the known labels comprises a single known classification associated with a given spreadsheet cell comprising a respective plurality of characters;
processing, by the machine learning model, the character-level embeddings through one or more bi-directional long short term memory (LSTM) layers;
outputting, by the machine learning model based on the processing, a predicted label for the text string indicating a classification of the text string, wherein the predicted label comprises a single classification for the plurality of characters in the text string from the cell of the spreadsheet; and
performing, by a computing application, one or more actions based on the text string and the predicted label.

2. The method of claim 1, wherein determining, by the machine learning model, the character-level embeddings further comprises:
generating the one-hot encoded vectors of the plurality of characters using a character dictionary.

3. (canceled)

4. The method of claim 2, wherein the character dictionary comprises mappings of characters to numerical identifiers.

5. The method of claim 1, further comprising processing, by the machine learning model, one or more outputs from the one or more bi-directional LSTM layers through one or more fully-connected layers.

6. The method of claim 5, further comprising processing, by the machine learning model, one or more outputs from the one or more fully-connected layers, through a softmax layer to determine the predicted label.

7. The method of claim 1, wherein performing, by the computing application, the one or more actions based on the text string and the predicted label comprises one or more of:
automatically populating a particular variable with the text string based on the predicted label; or
providing output to a user via a user interface based on the text string and the predicted label.

8. The method of claim 1, further comprising:
receiving user input related to the predicted label; and
generating updated training data for re-training the machine learning model based on the user input and the text string.

9. A method for training a machine learning model, comprising:
receiving, by a machine learning model, inputs comprising a plurality of characters in a text string from a cell of a spreadsheet, wherein the text string is associated with a known label indicating a classification of the text string, wherein the classification indicated in the known label comprises a single known classification associated with the cell of the spreadsheet comprising the plurality of characters;
processing, by the machine learning model, the inputs through an embedding layer that determines character-level embeddings of the plurality of characters, wherein:
each respective character-level embedding of the character-level embeddings is a vector representation of a respective character of the plurality of characters;
the embedding layer comprises a plurality of nodes that apply matrix transformations to one-hot encoded vectors representing the plurality of characters in order to produce vectors of floating point values; and
the matrix transformations involve a matrix learned through a supervised training process;
processing, by the machine learning model, the character-level embeddings through one or more bi-directional long short term memory (LSTM) layers;
determining, by the machine learning model based on one or more outputs from the one or more bi-directional LSTM layers, a predicted label for the text string, wherein the predicted label comprises a single classification for the plurality of characters in the text string from the cell of the spreadsheet; and
adjusting one or more parameters of the embedding layer based on a comparison of the predicted label with the known label.

10. The method of claim 9, further comprising adjusting one or more parameters of the one or more bi-directional LSTM layers based on the comparison of the predicted label with the known label.

11. The method of claim 9, further comprising:
processing, by the machine learning model, the one or more outputs from the one or more bi-directional LSTM layers through one or more fully-connected layers; and
adjusting one or more parameters of the one or more fully-connected layers based on a comparison of the predicted label with the known label.

12. The method of claim 9, wherein processing, by the machine learning model, the inputs through the embedding layer further comprises:
generating the one-hot encoded vectors of the plurality of characters using a character dictionary.

13. The method of claim 12, wherein adjusting the one or more parameters of the embedding layer based on the comparison of the predicted label with the known label comprises adjusting one or more values of the matrix.

14. A system, comprising:
one or more processors; and
a memory comprising instructions that, when executed by the one or more processors, cause the system to:
determine, by a machine learning model, character-level embeddings of a plurality of characters in a text string from a cell of a spreadsheet, wherein:
the character level embeddings are determined by an embedding layer of the machine learning model comprising a plurality of nodes that apply matrix transformations to one-hot encoded vectors representing the plurality of characters in order to produce vectors of floating point values;
the matrix transformations involve a matrix learned through a supervised training process;
each respective character-level embedding of the character-level embeddings is a vector representation of a respective character of the plurality of characters; and
the machine learning model was trained to determine the character-level embeddings based on training data comprising text strings associated with known labels indicating known classifications of the text strings, wherein each of the known labels comprises a single known classification associated with a given spreadsheet cell comprising a respective plurality of characters;
process, by the machine learning model, the character-level embeddings through one or more bi-directional long short term memory (LSTM) layers;
output, by the machine learning model based on the processing, a predicted label for the text string indicating a classification of the text string, wherein the predicted label comprises a single classification for the plurality of characters in the text string from the cell of the spreadsheet; and
perform, by a computing application, one or more actions based on the text string and the predicted label.

15. The system of claim 14, wherein determining, by the machine learning model, the character-level embeddings further comprises:
generating the one-hot encoded vectors of the plurality of characters using a character dictionary.

16. (canceled)

17. The system of claim 15, wherein the character dictionary comprises mappings of characters to numerical identifiers.

18. The system of claim 14, wherein the instructions, when executed by the one or more processors, further cause the system to process, by the machine learning model, one or more outputs from the one or more bi-directional LSTM layers through one or more fully-connected layers.

19. The system of claim 18, wherein the instructions, when executed by the one or more processors, further cause the system to process, by the machine learning model, one or more outputs from the one or more fully-connected layers, through a softmax layer to determine the predicted label.

20. The system of claim 14, wherein performing, by the computing application, the one or more actions based on the text string and the predicted label comprises one or more of:
automatically populating a particular variable with the text string based on the predicted label; or
providing output to a user via a user interface based on the text string and the predicted label.
